(19) United States
(12) Patent Application Publication
(10) Pub. No.: US 2008/0263364 A1
(43) Pub. Date: Oct. 23, 2008

(54) System and method for providing access to a computer resource

(76) Inventors: Alan H. Dundas, Los Altos, CA (US); Paul C. Lloyd, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/788,512

(22) Filed: Apr. 20, 2007

(51) Int. Cl. H04L 9/00

(52) U.S. Cl. 713/185

(57) ABSTRACT

There is provided a device and method for providing access to a computer resource. An exemplary device that is adapted to provide access to a computer resource comprises a Universal Serial Bus (USB) security token having a pressure sensor that is adapted to detect pressure applied to the USB security token, and a structure that is adapted to create authentication information to be provided to the computer resource in response to a detection of pressure by the pressure sensor. An exemplary method of providing access to a computer resource comprises detecting an application of pressure to a USB security token, and providing authentication information to the computer resource in response to the detection of the application of pressure to the USB security token.

### BACKGROUND

This section is intended to introduce the reader to various aspects of art, which may be related to various aspects of the present invention that are described or claimed below. This discussion is believed to be helpful in providing the reader with background information to facilitate a better understanding of the various aspects of the present invention. Accordingly, it should be understood that these statements are to be read in this light, and not as admissions of prior art.

Security tokens are physical devices and/or software that are used to authenticate access to a secure computer resource such as a virtual private network (VPN). A known type of security token is adapted to interface to a user computer via an existing communication interface such as a Universal Serial Bus (USB) port. Such security tokens typically store information that is used to authenticate users of secure systems, networks or other resources. Examples of resources other than secure networks that may be subject to access using a security token include web pages, PBX systems, routers or the like. An example of authentication information that may be stored on a security token is a digital certificate with a hardware-generated private key of an asymmetric key pair. This information stored on the token is accessed by the computer into which the token is inserted and presented to a server to which the computer is connected to obtain access to the network or resource. An underlying assumption of this type of token is that the person in possession of the token is an authorized user of the network or resource for which access is sought.

Some USB security tokens require entry of a secure personal identification number (PIN), which activates the performance of a cryptographic function with a private key that is stored on the token. The output of the cryptographic function is used to gain secure access to a network or other resource. Security tokens of this type offer the benefit that the private key is never directly transferred from the token itself.

A problem with the security tokens described above is that the computer into which the token is inserted may be infected with a virus or other malware that is designed to surreptitiously extract or use the authentication information stored on the token. This could be done by capturing the secure PIN or by exercising the cryptographic function that used to authenticate the user. In some cases, the theft of authentication information from the token could occur without the knowledge of the authorized user of the network or resource. With the authentication information extracted from the security token, unauthorized access to the secure network or resource could potentially be obtained. For example, the unauthorized user could potentially use the PIN to duplicate the operation of the cryptographic function using the private key to obtain access to the secure network or resource notwithstanding the fact that the unauthorized user does not physically possess the security token.

A “one-time passcode” device is another type of device that attempts to provide restricted access to secure networks and resources. A typical one-time passcode device generates a one-time passcode by the physical press of a hardware button. This one-time passcode together with a secure PIN provide a user authentication. The secure PIN is either entered into the device before generation of the one-time passcode, or it is combined with the one-time passcode (prefix or suffix) to authenticate the user. Subsequent attempts to access the network or resource using the same passcode are denied. An underlying assumption of one-time passcode systems is that the individual in possession of the device and the corresponding PIN is an authorized user of the secure network or resource. One-time passcode devices are not subject to software attacks because they are not physically connected to a computer that is accessing the secure network or resource. Nonetheless, the use of a separate device to generate a passcode that must be manually entered and that is accepted only one time is inconvenient and cumbersome.

### BRIEF DESCRIPTION OF THE DRAWINGS

Certain exemplary embodiments are described in the following detailed description and in reference to the drawings, in which:

FIG. 1 is a block diagram of a network access system according to an exemplary embodiment of the present invention;

FIG. 2 is a block diagram of a security token according to an exemplary embodiment of the present invention;

FIG. 3 is a state diagram showing the operation of a security token according to an exemplary embodiment of the present invention; and

FIG. 4 is a flow chart showing a method of providing access to a computer network according to an exemplary embodiment of the present invention.

### DETAILED DESCRIPTION OF SPECIFIC EMBODIMENTS

One or more exemplary embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary embodiment of the present invention comprises a security token that includes a circuit and/or other device adapted to detect whether a user is physically present in the immediate vicinity of the security token while the token is being used to gain secure access to a computer network or resource. In one exemplary embodiment, a security token has a button that the user physically presses while attempting to gain access to the secure network or resource. The security token is adapted to create authentication information such as a cryptographic function or transaction that utilizes a private key stored on the security token when the user presses the button. Such a system helps to ensure that an attempt to gain access to a network or resource is being made by an authorized user who is in physical possession of the security token and not by malicious software that may have surreptitiously obtained the information needed to generate the authentication information from the security token without the authorized user's knowledge. In an exemplary embodiment of the present invention, the pressing of the physical presence detection button is required in addition to the entry of other information such as a secure PIN to cause the security token to generate the authentication information.

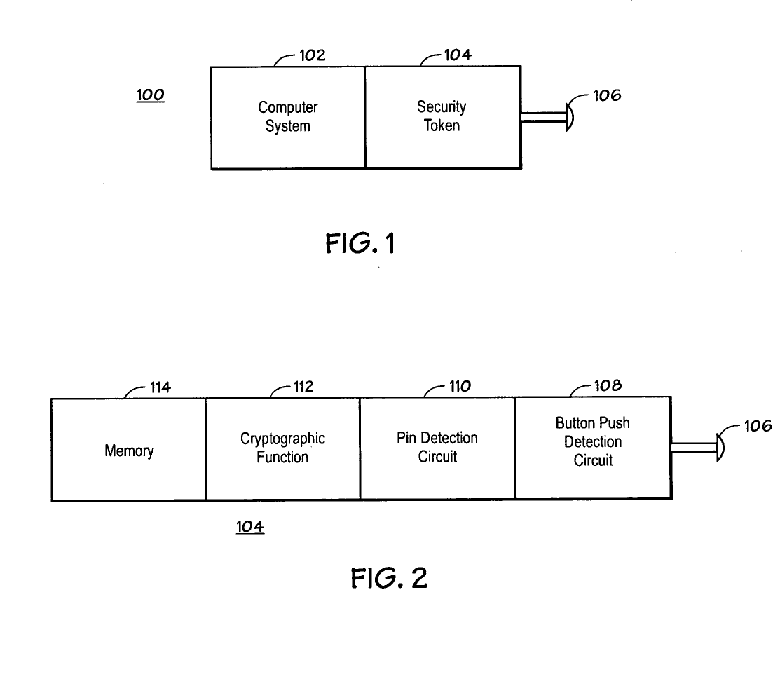

FIG. 1 is a block diagram of a network access system according to an exemplary embodiment of the present invention. The network access system is generally represented by the reference number 100. The network access system 100 includes a computer system 102. The computer system 102 is adapted to receive a security token 104 via a communication port of the computer system 102. In an exemplary embodiment of the present invention, the security token 104 is adapted to be plugged into a USB port of the computer system 102. The security token 104 includes a pressure sensor 106, which is adapted to be pressed by a user of the system to confirm that the user is physically present. The pressure sensor 106 may comprise a switch, a button or the like. The operation of the security token 104 is explained in greater detail below.

FIG. 2 is a block diagram of a security token according to an exemplary embodiment of the present invention. The security token is generally represented by the reference number 104. The security token 104 comprises a button-push detection circuit 108, which is adapted to detect when the pressure sensor 106 is pressed by the user. The security token 104 further includes a PIN detection circuit 110, a cryptographic function 112 and a memory 114.

The PIN detection circuit 110 is adapted to detect and verify the entry of a secure PIN by the user. The entry of the secure PIN may be used as a requirement before the security token 104 generates authentication information to allow the user to gain access to a secure network or resource. Although the PIN detection circuit 110 is shown as a portion of the security token 104, those of ordinary skill in the art will appreciate that the PIN detection circuit 110 may be disposed external to the security token 104. For example, the PIN detection circuit 110 may be disposed in a computer system that is adapted to receive the security token 104, such as the computer system 102 (FIG. 1).

The memory 114 may comprise any sort of storage device, such as random access memory (RAM), read-only memory (ROM), flash memory or the like. Those of ordinary skill in the art will appreciate that the selection of memory type is a matter of design choice.

The structure of the cryptographic function 112 may comprise hardware, software or a combination of both, as will be appreciated by those of ordinary skill in the art. In response to detection of the pressing of the pressure sensor 106 by the button-push detection circuit 108, the cryptographic function 112 is adapted to create authentication information to allow the user to gain access to a secured network or resource. The cryptographic function 112 may operate on information that is stored in the memory 114. In an exemplary embodiment of the present invention, the information stored in the memory 114 comprises a private key. In this exemplary embodiment, the authentication information generated is the result of the operation of the cryptographic function 112 on the private key stored in the memory 114. By controlling the operation of the cryptographic function 112 so that authentication information is generated only when the user is physically present, unauthorized access to the secure network or resource associated with the token via a software attack using information stolen from the token is prevented.

In an exemplary embodiment of the present invention, the operation of the cryptographic function 112 may be further limited so that the cryptographic function 112 operates only when additional information is received by the token and not just upon the detection of the physical presence of the user. In one example, entry of a secure PIN is required.

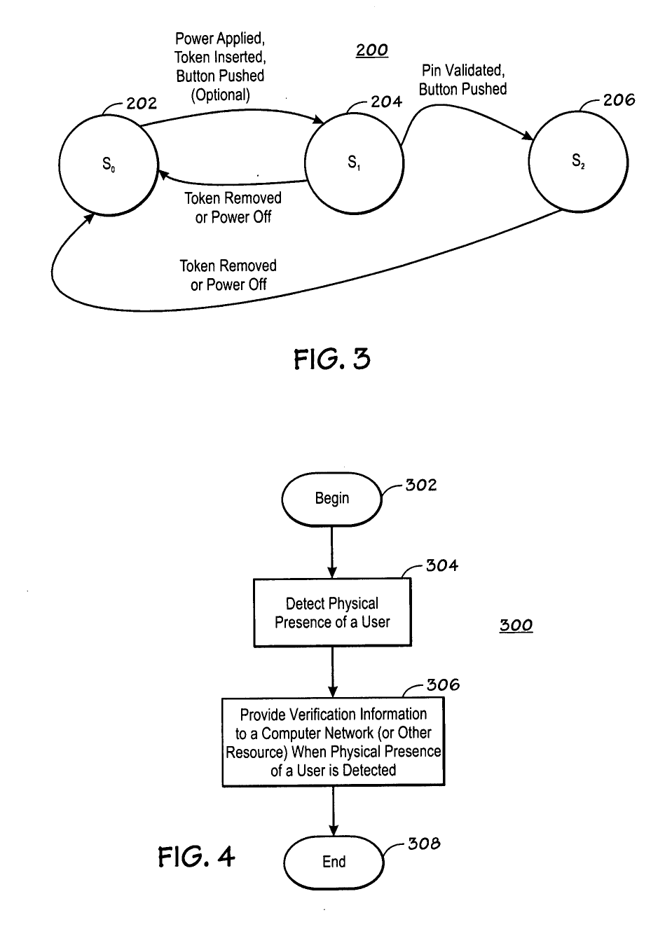

FIG. 3 is a state diagram showing the operation of a security token according to an exemplary embodiment of the present invention. The state diagram is generally represented by the reference number 200. The state diagram 200 comprises three states: an S₀ 202 state, an S₁ 204 state and an S₂ 206 state. In the So 202 state, the security token 104 (FIG. 2) is either not inserted in the computer system 102 (FIG. 1) or power to the computer system 102 (FIG. 1) is not applied. The security token 104 (FIG. 2) enters the S. 204 state when the token is inserted into the computer system 102 (FIG. 1), power is applied to the computer system 102 (FIG. 1) and optionally the physical presence detection button 106 is pressed by the user. The token remains in the S₁ 204 state until entry of a secure PIN and an additional required detection that the pressure sensor 106 (FIG. 2) has been pressed by the user. When the token enters the S₂ 206 state, authentication information is provided by the token to allow access to a secure network or resource. From the both the S₂ 206 state and the S₁ 204 state, the security token 104 (FIG. 2) re-enters the S₀ 202 state when the token is removed from the computer system 102 (FIG. 1) or when power to the computer system 102 (FIG. 1) is removed.

The security token 104 (FIG. 2) may use a state machine to determine when to employ the cryptographic function 112 to generate authentication information and to transfer the authentication information to the computer system 102 via the communication interface connecting the security token 104 (FIG. 2) to the computer system 102 (FIG. 1). In the example set forth above, the cryptographic function 112 (FIG. 2) would only generate authentication information and provide that information to the computer system 102 (FIG. 1) when in the state S₂ 206. The state information may be maintained in a state table on the security token 104 (FIG. 2) and not transferred to the computer system 102 (FIG. 1).

Additionally, secure information such as the private key stored on the token and/or the user's secure PIN (which must be present on the token to allow validation when the user enters the PIN) is never transferred from the security token 104 (FIG. 2). In this manner, opportunities to steal the secure information stored on the token are reduced.

FIG. 4 is a flow chart showing a method of providing access to a computer network according to an exemplary embodiment of the present invention. The flow chart is generally represented by the reference number 300. At block 302, the method begins. At block 304, the physical presence of a user is detected. In an exemplary embodiment of the present invention, the physical presence of the user is detected when the user presses a button, as set forth above.

Authentication information is provided to a computer network when the physical presence of the user is detected, as shown at block 306. In an exemplary embodiment of the present invention, additional steps beyond mere physical presence of the user may be required before the authentication information is generated and provided to the computer network. As set forth above, one example of such information may be the entry of a secure PIN by the user. When all necessary conditions are met, the authentication information is generated, for example, by a cryptographic function. The authentication information, once produced, is transmitted to the computer system 102 (FIG. 1) via the communication interface into which the security token 104 (FIG. 2) is inserted. The computer system 102 (FIG. 1) then transmits the authentication information to a remote computer to which access is sought.

Those of ordinary skill in the art will appreciate that embodiments of the present invention reduce the likelihood of theft of information or unauthorized use of information that may be used to provide access to secure computer networks or resources. Embodiments of the present invention may be used to protect end-user client computers, which have a higher likelihood of being compromised than computers maintained in a controlled IT environment such as a data center.

As mentioned above, one or more of the particular embodiments disclosed herein may be used in combination with other exemplary embodiments herein disclosed. The exemplary embodiments provide a reasonable level of security and deterrent effect without incurring cost. Specifically, the exemplary embodiments are able to be implemented on a standard motherboard and chassis. Additionally, by not using a standard boot procedure, the methods prevents use of standard tools, such as DOS tools, and is therefore resistant to being attacked and compromised by use of those tools.

What is claimed is:

1. A Universal Serial Bus (USB) security token that is adapted to provide access to a computer resource, the USB security token comprising:
a pressure sensor that is adapted to detect pressure applied to the USB security token; and
a structure that is adapted to create authentication information to be provided to the computer resource in response to a detection of pressure by the pressure sensor.

2. The USB security token recited in claim 1, comprising a button that is adapted to actuate the pressure sensor.

3. The USB security token recited in claim 1, wherein the structure that is adapted to create authentication information creates the authentication information by performing a cryptographic function.

4. The USB security token recited in claim 3, wherein the cryptographic function is performed using a private key of an asymmetric key pair.

5. The USB security token recited in claim 1, wherein a personal identification number (PIN) detection circuit is adapted to detect entry of a PIN in association with the detection of pressure.

6. The USB security token recited in claim 5, wherein the structure that is adapted to create authentication information is adapted to create the authentication information in response to the detection of pressure only if entry of the PIN is detected by the PIN detection circuit.

7. The USB security token recited in claim 5, wherein a status of the pressure sensor and a status of the PIN detection circuit are maintained by a state machine.

8. The USB security token recited in claim 1, wherein the computer resource comprises a secure network, a web page, a PBX system or a router.

9. The USB security token recited in claim 1, wherein the pressure sensor comprises a switch or a button.

10. A system that is adapted to provide access to a computer resource, the system comprising:
a computer system; and
a USB security token that is adapted to interface with the computer system, the USB security token comprising a pressure sensor that is adapted to detect pressure applied to the USB security token and a structure that is adapted to create authentication information to be provided to the computer resource in response to a detection of pressure by the pressure sensor.

11. The system recited in claim 10, wherein the structure that is adapted to create authentication information creates the authentication information by performing a cryptographic function.

12. The system recited in claim 11, wherein the cryptographic function is performed using a private key of an asymmetric key pair.

13. The system recited in claim 10, wherein a personal identification number (PIN) detection circuit is adapted to detect entry of a PIN in association with the detection of pressure.

14. The system recited in claim 13, wherein the structure that is adapted to create authentication information is adapted to create the authentication information in-response to the detection of pressure only if entry of the PIN is detected by the PIN detection circuit.

15. The system recited in claim 13, wherein a status of the pressure sensor and a status of the PIN detection circuit are maintained by a state machine.

16. The system recited in claim 10, wherein the USB security token comprises a button that is adapted to actuate the pressure sensor.

17. The system recited in claim 10, wherein the computer resource comprises a secure network, a web page, a PBX system or a router.

18. The system recited in claim 10, wherein the pressure sensor comprises a switch or a button.

19. A method of providing access to a computer resource using a USB security token, the method comprising:
detecting an application of pressure to the USB security token; and
providing authentication information to the computer resource in response to the detection of the application of pressure to the USB security token.

20. The method recited in claim 19, comprising performing a cryptographic function to create the authentication information.

21. The method recited in claim 20, wherein the cryptographic function is performed using a private key of an asymmetric key pair.

22. The method recited in claim 19, wherein the act of providing authentication information to the computer resource in response to the detection of the application of pressure to the USB security token is only performed upon entry of a personal identification number (PIN).
